(19) United States
(12) Patent Application Publication
(10) Pub. No.: US 2004/0029581 A1
(43) Pub. Date: Feb. 12, 2004

(54) Mobile phone being separated into handset and host phone which could be used as a PDA and communication method thereof

(75) Inventor: Yifeng Lu, Shenzhen (CN)

Correspondence Address: BACON & THOMAS, PLLC, 625 SLATERS LANE, FOURTH FLOOR, ALEXANDRIA, VA, 22314

(73) Assignee: Huawei Technologies Co., Ltd., Shenzhen (CN)

(21) Appl. No.: 10/437,429

(22) Filed: May 14, 2003

Related U.S. Application Data
(63) Continuation of application No. PCT/CN01/01170, filed on Jul. 11, 2001.

(30) Foreign Application Priority Data
Nov. 18, 2000 (CN) 00133068.3

(51) Int. Cl. H04Q 7/20

(52) U.S. Cl. 455/426.1; 455/462; 455/571

(57) ABSTRACT

The invention discloses a separated mobile phone comprises a host-phone and a handset. The host-phone includes a wireless modem module, a main controller, a control signal interface, a digital audio interface, a low-power wireless transceiver module and a PDA device. The handset comprises a main controller, a display, a microphone, a speaker, a keyboard and a low-power wireless transceiver module. The low-power wireless transceiver module in host-phone can be set inside or outside. Communication modules between the host-phone and handset use Bluetooth protocol or Home Radio Frequency protocol. The host-phone and handset can access to public switched telephone network through a home cordless telephone.

### FIELD OF THE TECHNOLOGY

The present invention relates generally to a mobile phone in the wireless communication field, particularly to a mobile phone separated into a handset and a host-phone with PDA function and communication method between them.

### BACKGROUND OF THE INVENTION

It is a development trend that size of a wireless terminal is getting small, and functions of a wireless terminal are getting strong. For example, personal digital assistance (PDA) function has been added to a wireless terminal, so a wireless terminal can record telephone numbers, recognize handwriting, transmit and receive mails etc. In the future, functions, such as accessing to a network and multimedia communication, will also be added. However, all these add-on functions have some conflict with the basic telephone function of a wireless terminal.

When adding the PDA function, it is required that a wireless terminal has a bigger display panel in order to read a file, a mail, or scan an image easily. The result is that the size of a wireless terminal will be increased, and this will be inconvenient for carrying and listening a telephone. Consequently, the add-on PDA function affects the basic telephone function.

At present, for a wireless terminal with PDA function, some with smaller display panel is inconvenient for reading, writing or connecting to a network; some with bigger display panel is inconvenient for grasping at hand to listen a telephone call. Obviously, for the present wireless terminal, if PDA function is further strengthened, the basic function, as a mobile phone, must be affected. For example, increasing display panel size will make a mobile phone being inconvenient for grasping at hand. If using a hands-free earphone, usually it does not have ringing function. It is inconvenient for grasping at hand, and has some trouble to listen a phone call.

Besides, it is desired that a mobile phone can work with telephone at home in complement. When a subscriber goes out, a mobile phone is used for communication; when the subscriber is back home, communication is automatically switched to the telephone at home to save the communication cost.

A China Patent, numbered “98106704.2” and titled “Separated Mobile Phone for Radiation Protection”, discloses a technical scheme of a separated mobile phone. In this technical scheme, a mobile phone is divided (separated) into two parts: one has a translator with emitting function; another one has a handset with receiving function. Connection between the translator and the handset can be wire mode or micro-power wireless mode. This technical scheme solves the problem that emitting electromagnetic wave with a larger power leaves the human brain far enough, i.e., the radiation protection problem. However, the technical scheme does not solve the problem that adding on the PDA function in a mobile phone conflicts with using convenience of a telephone function in the mobile phone.

### SUMMARY OF THE INVENTION

The purpose of the invention is to provide a separated mobile phone with PDA function and a communication method thereof. The mobile phone is convenient for use and carrying. The mobile phone solves conflict between using telephone conveniently and adding on PDA function, which cause size of a mobile phone bigger. In addition, the mobile phone solves complementary use of a mobile phone and a telephone at home. Further, the mobile phone solves radiation protection problem.

The invention is implemented with a technical scheme as follow: a separated mobile phone comprises a host-phone and a handset, and both are independent in space.

The host-phone comprises a wireless modem module, a main controller, a control signal interface, a digital audio interface, a low-power wireless transceiver module and a PDA device. The wireless modem module, the control signal interface and the PDA device are connected with the main controller, respectively. The digital audio interface is connected with the wireless modem module. The digital audio interface and the control signal interface are connected with the low-power wireless transceiver module, respectively.

The handset comprises a main controller, a display, a microphone, a speaker, a keyboard and a low-power wireless transceiver module. The display, the microphone, the speaker and the low-power wireless transceiver module are connected to the main controller, respectively. The keyboard is connected with the low-power wireless transceiver module. The low-power wireless transceiver module in the handset corresponds to the low-power wireless transceiver module in the host-phone.

The invention is further implemented with a communication method that includes a sending method and a receiving method for communication between two separated parts of a mobile phone.

The sending method works as follow. An audio signal coming from the microphone of the handset is sent to the low-power wireless transceiver module for transmitting after having been processed by the main controller. The transmitted signal is received by the low-power wireless transceiver module in the host-phone, and transferred to the wireless modem module through the digital audio interface. After having been processed and modulated in the wireless modem module, the signal is emitted in the air.

The receiving method works as follow. A signal, coming from the air, is demodulated by the wireless modem module in the host-phone and recovered to an audio signal, which is then transferred to the low-power wireless transceiver through the digital audio interface. The recovered audio signal is modulated by the low-power wireless transceiver and transmitted to the handset in a short distance. In the handset, the modulated audio signal is received and demodulated to an audio signal by the low-power wireless transceiver module. Under control of the main controller, the audio signal is sent to the speaker in the handset to output.

A control command, sent out by the keyboard in the handset, is first modulated by the low-power wireless transceiver module, and then transmitted to the low-power wireless transceiver module in the host-phone. In the host-phone, the control command is solved by the control signal interface and the main controller, then it is modulated and emitted to the air by the wireless modem module.

A control command, coming from the air, is received and demodulated by the wireless modem module in the host-phone. After having been passed through the main controller and the control signal interface, the control command is modulated and transmitted to the handset by the low-power wireless transceiver module in the host-phone. In the handset, the low-power wireless transceiver module receives the control command, and the display shows the control command after having been processed by the main controller.

Both low-power wireless transceiver modules in the host-phone and the handset use the Bluetooth protocol or HomeRF protocol.

The low-power wireless transceiver module in the host-phone can be set inside or outside the host-phone.

It can be seen from the technical scheme, mentioned above, the invention has the following advantages, which makes the invention purpose to be reached.

1) Since the host-phone includes a PDA device, the mobile phone of the invention has functions of a general PDA product, such as electronic notebook, handwriting input and electronic dictionary. It can have functions, such as accessing to internet with WAP/iMode, sending and receiving an email or a short message. It can also have functions, such as receiving broadcast message, image communication, videotext, sending and receiving facsimile, etc.

2) Since the handset includes a display, a microphone, a speaker, a keyboard and a low-power wireless transceiver module, the mobile phone of the invention has functions of a conventional mobile phone, such as dialing, conversation, ringing, displaying a call and listening rejection, etc. The handset of the mobile phone can be set as a handset of a home cordless telephone. In addition, since the handset pages the host-phone periodically, the mobile phone has the function of stolen protection.

3) Since the host-phone and the handset are separated and the handset can control the host-phone, so it is possible to add-on some more complicated functions in the host-phone without loosing convenience.

4) Since the low-power wireless transceiver modules in the host-phone and the handset use the Bluetooth protocol or the HomeRF protocol, the handset emitting power is very small, so it is effectively reduced the radiation for human brain and is good for human health.

5) Since the handset can be set as a handset of a home cordless telephone, so when a subscriber is at home, the fixed telephone is used in priority to save the communication cost.

### BRIEF DESCRIPTION OF THE DRAWINGS

FIG. 1 shows a logical diagram of a host-phone with inside low-power wireless transceiver module.

FIG. 2 shows a logical diagram of a host-phone with outside low-power wireless transceiver module.

FIG. 3 shows a logical diagram of a handset.

FIG. 4 shows a principle diagram of a host-phone and handset working in the invention.

### EMBODIMENTS OF THE INVENTION

The invention will be described in more detail, hereinafter, with reference to drawings and embodiments.

In the invention, principle of the host-phone working and the handset working is described in FIG. 4. A mobile phone of the invention includes a host-phone (PDA+wireless Modem) 2 and a handset 1. The handset 1 connects with a mobile communication system (wireless communication network) 3, such as GSM/GPRS, WCDMA, CDMA 2000, TD-SCDMA and UWC136, through host-phone 2 and its air interface. When the handset 1 is set as a handset of a home cordless telephone 4, the handset 1 connects with a wire communication network 5 (public switched telephone network (PSTN)) through the host-phone of the cordless telephone 4. At the same time, the host-phone 2 also can access to PSTN through the cordless telephone 4. The handset 1 can implement dialing a phone call and listening a phone call through the wireless communication such as Bluetooth or HomeRF between the handset 1 and the host-phone 2. The handset size can be smaller for carrying and listening easily. The host-phone size can be larger for setting a larger display panel. Since distance between the host-phone 2 and the handset 1 is shorter, emission power can be very small.

Specifically, the mobile phone of the invention is implemented with the following scheme.

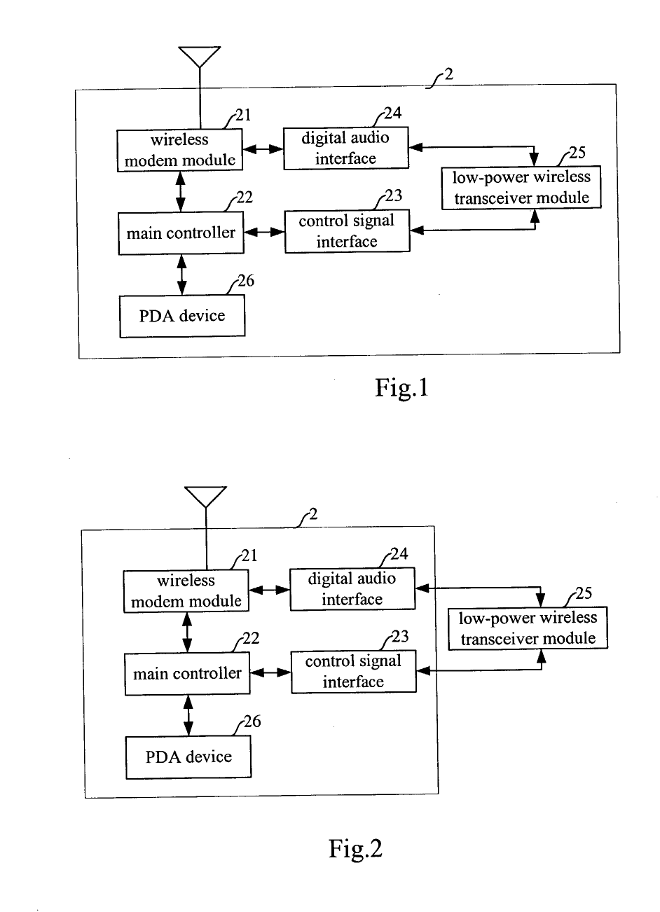

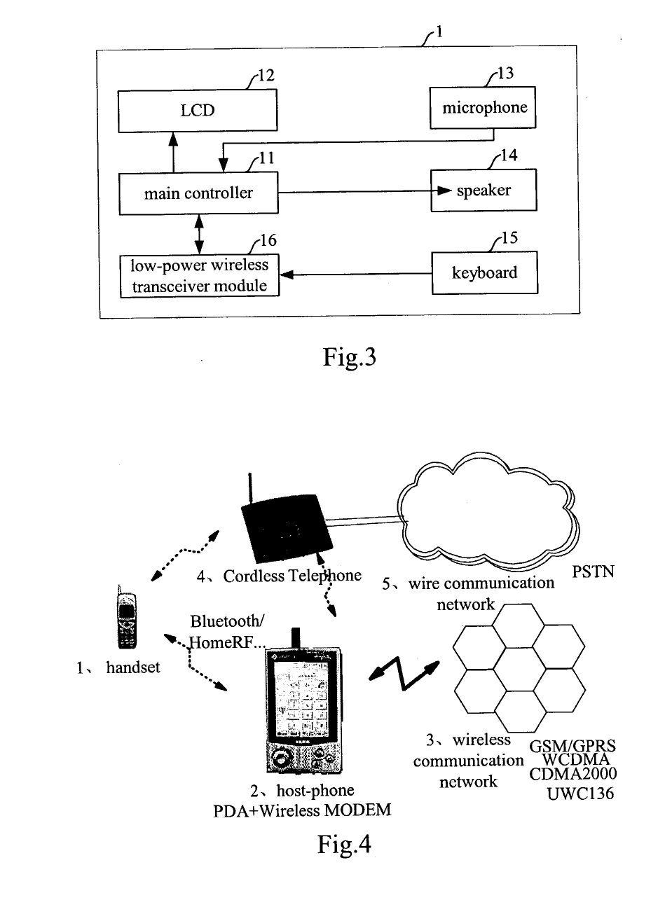

Reference to FIGS. 1, 2 and 3, a mobile phone of the invention is consisted of a separated host-phone 2 (as shown in FIG. 1 and FIG. 2) and a separated handset 1 (as shown in FIG. 3).

The host-phone 2 comprises a wireless modem module 21, a main controller 22, a control signal interface 23, a digital audio interface 24, a low-power wireless transceiver module 25 and a PDA device 26. The wireless modem module 21, the control signal interface 23 and the PDA device 26 are connected with the main controller 22, respectively. The digital audio interface 24 is connected with the wireless modem module 21. The digital audio interface 24 and the control signal interface 23 are connected with the low-power wireless transceiver module 25, respectively. The wireless modem module 21 is connected with an antenna. The low-power wireless transceiver module 25 of the host-phone 2 in FIG. 1 is inside and the low-power wireless transceiver module 25 of the host-phone 2 in FIG. 2 is outside.

The handset 1 comprises a main controller 11, a liquid crystal display (LCD) 12, a microphone 13, a speaker 14, a keyboard 15 and a low-power wireless transceiver module 16. The low-power wireless transceiver module 16 corresponds to the lowpower wireless transceiver module 25 in the host-phone 2. The LCD 12, the microphone 13, the speaker 14 and the low-power wireless transceiver module 16 are connected to the main controller 11, respectively. The keyboard 15 is connected with the low-power wireless transceiver module 16.

When the mobile phone is sending an audio signal, the audio signal coming from the microphone 13 of handset 1 and having been processed by the main controller 11, is sent to the low-power wireless transceiver module 16 for transmitting. After the transmitted signal has been received by the low-power wireless transceiver module 25 in the host-phone 2, it is transferred to the wireless modem module 21 through the digital audio interface 24. After having been processed and modulated in the wireless modem module 21, the signal is emitted in the air by the antenna.

When the mobile phone is receiving a signal, the signal coming from the air, is demodulated by the wireless modem module 21 and recovered to an audio signal, which is then transferred to the low-power wireless transceiver 25 through the digital audio interface 24. The audio signal is modulated by the low-power wireless transceiver 25 and transmitted to the handset 1 in a short distance. In the handset 1, the modulated audio signal is demodulated to an audio signal by the low-power wireless transceiver module 16. The audio signal is sent to the speaker 14 for output, under control of the main controller.

When the mobile phone is sending a control command, the control command sent out by the keyboard 15 in the handset 1, is first modulated by the low-power wireless transceiver module 16, and then transmitted to the low-power wireless transceiver module 25 in the host-phone 2. In the host-phone 2, the control command is solved by the control signal interface 23 and the main controller 22, then it is modulated and emitted to the air by the wireless modem module 21.

When the mobile phone is receiving a control command, the control command coming from the air, is modulated and transmitted to the handset 1 by the low-power wireless transceiver module 25 in the host-phone, after having been passed through the wireless modem module 21, the main controller 22 and the control signal interface 23. In the handset 1, the low-power wireless transceiver module 16 receives the control command, and the LCD displays the control command after having been processed by the main controller 11.

The low-power wireless transceiver modules 25 and 16 can use Bluetooth protocol or home radio frequency (HomeRF) protocol. The working frequency between the host-phone 2 and the handset 1 is 2.4 GHz. Of course, other frequency can also be used.

The low-power wireless transceiver module 25 of host-phone 2 can be set inside or outside, as shown in FIG. 1 and FIG. 2, respectively.

The control signal interface 23 in host-phone 2 can be a RS232 interface or a USB interface.

Bluetooth protocol is a protocol that provides short distance wireless communication. Purpose of the protocol is to replace cable connection between electronic equipment with a wireless mode. The protocol can work at ISM frequency band (Industrial, Scientific and Medical Frequency Band) without application. When the protocol works at FDD (Frequency Division Duplex) mode, the maximum emission power can reach 100 mw and symbol rate is 1 Mb/s. The protocol provides “point to point” or “point to multipoint” connection, and works at hopping frequency mode and has about 10 meters communication distance.

HomeRF mode is a short distance communication mode based on wireless LAN technology and DECT (Digital European Cordless Telecommunication) technology. Purpose of the mode is to establish a wireless local area network at home. The mode also can work at ISM frequency band without application. Frame structure of the mode is a mixture of TDMA (Time Division Multiple Access) mode and CSMA (Carrier Sense Multiple Access) mode, which is a combination of DECT frame structure and wireless LAN frame structure. The mode takes into account requirement of voice communication and high-speed data communication, and can support six full-duplex voice communications or a 2 Mb/s data communication. The HomeRF mode also uses hopping frequency mode, and has an emission power of 100 mw and 50 meters communication distance. HomeRF will have a bright application future for household appliances communication.

In the invention mobile phone, the low-power wireless transceiver modules in host-phone and handset use Bluetooth protocol or HomeRF protocol so that the purpose of the invention can be achieved.

In the invention, the mobile phone has the following embodiments:

1) The handset is a supplementary part of the host-phone, and the interface unit (the low-power wireless transceiver module) between the host-phone and the handset is integrated inside the host-phone;

2) The interface unit (the low-power wireless transceiver module) between the host-phone and the handset is independent from the host-phone in space, the low-POWER wireless transceiver module is connected with the main controller of the host-phone by RS232 or USB interface (the control signal interface), and the control command uses AT command set. The microphone of the mobile phone input an audio signal, and the speaker output an audio signal.

During using the mobile phone, a subscriber can keep the host-phone in a carrying dispatch-case or pocket, and takes the handset at hand. When a subscriber wants to call out, a callee telephone number is directly dialed at the handset, and the handset controls the host-phone to hook off and send out the telephone number. When it has been connected, the subscriber uses directly the handset to make conversation with the callee. When there is a call in, the handset rings and displays the caller telephone number, and the subscriber uses the handset to listen the call directly.

When there are an image or a document to be transferred, a subscriber uses the PDA function at the host-phone, and a call can be switched to the host-phone. When the host-phone is in a wait state, the handset can page the host-phone periodically. If there is no acknowledgement, the handset will alarm to warn the subscriber that the host-phone may be lost or stolen.

When a subscriber is at home, the host-phone or handset can be connected to the home cordless telephone, automatically or manually. When the subscriber wants to use a telephone or access to a network, using the cordless telephone to access to PSTN is priority.

1. A separated mobile phone with PDA function, the mobile phone comprising a host-phone and a handset, and both are independent in space:
the host-phone including a wireless modem module, a main controller, a control signal interface, a digital audio interface, a low-power wireless transceiver module and a PDA device; the wireless modem module, the control signal interface and the PDA device being connected with the main controller, respectively; the digital audio interface being connected with the wireless modem module; the digital audio interface and the control signal interface being connected with the low-power wireless transceiver module, respectively;
the handset including a main controller, a display, a microphone, a speaker, a keyboard and a low-power wireless transceiver module; the display, the microphone, speaker and the low-power wireless transceiver module being connected to the main controller, respectively; the keyboard being connected with the low-power wireless transceiver module.

2. The separated mobile phone with PDA function according to claim 1, the low-power wireless transceiver module in the host-phone and the handset is a Bluetooth protocol module.

3. The separated mobile phone with PDA function according to claim 1, the low-power wireless transceiver module in the host-phone and the handset is a Home Radio Frequency protocol module.

4. The separated mobile phone with PDA function according to claim 1, the low-power wireless transceiver module of the host-phone is outside the host-phone.

5. The separated mobile phone with PDA function according to claim 1, the low-power wireless transceiver module of the host-phone is inside the host-phone.

6. The separated mobile phone with PDA function according to claim 1, working frequency between the host-phone and the handset of the mobile phone is 2.4 GHz.

7. The separated mobile phone with PDA function according to claim 1, the control signal interface in the host-phone is a RS232 interface.

8. The separated mobile phone with PDA function according to claim 1, the control signal interface in the host-phone is an USB interface.

9. A communication method of a separated mobile phone with PDA function, comprising a sending method and a receiving method:
the sending method including: an audio signal coming from a microphone of a handset, after having been processed by a main controller of the handset, being sent to a low-power wireless transceiver module for transmitting; the transmitted signal being received by a low-power wireless transceiver module in a host-phone, and being transferred to a wireless modem module through a digital audio interface; after having been processed and modulated in the wireless modem module, the signal being emitted in air;
the receiving method including: a signal coming from air, being demodulated by the wireless modem module in the host-phone and being recovered to an audio signal, which then being transferred to the low-power wireless transceiver through the digital audio interface; the recovered audio signal being modulated by the low-power wireless transceiver and being transmitted to the handset in a short distance; in the handset, the modulated audio signal being received and demodulated to an audio signal by the low-power wireless transceiver module; the audio signal being sent to the speaker in the handset to output, under control of the main controller of the handset;
further including: a control command, sent out by a keyboard in the handset, being first modulated by the low-power wireless transceiver module, and then transmitted to the low-power wireless transceiver module in the host-phone; in the host-phone, the control command being solved by a control signal interface and the main controller, then being modulated and emitted to air by the wireless modem module;
a control command coming from air, being received and demodulated by the wireless modem module in the host-phone; after having been passed through the main controller and the control signal interface, the control command being modulated and transmitted to the handset by the low-power wireless transceiver module in the host-phone; in the handset, the control command being received by the low-power wireless transceiver module, and shown on a display after having been processed by the main controller.

10. The communication method according to claim 9, the host-phone and the handset of the mobile phone accessing to public switched telephone network through a host-phone of cordless telephone.
